(19) United States
(12) Patent Application Publication
(10) Pub. No.: US 2016/0181668 A1
(43) Pub. Date: Jun. 23, 2016

(54) LITHIUM-ION SECONDARY BATTERY

(71) Applicant: TOYOTA JIDOSHA KABUSHIKI KAISHA, Aichi (JP)

(72) Inventor: Masahiro MORITA, Nisshin-shi (JP)

(73) Assignee: TOYOTA JIDOSHA KABUSHIKI KAISHA, Toyota-shi, Aichi (JP)

(21) Appl. No.: 14/892,868

(22) PCT Filed: Jun. 5, 2013
(86) PCT No.: PCT/JP2013/003539

§ 371 Date: Nov. 20, 2015

(51) Int. Cl. H01M 10/0587; H01M 4/485; H01M 10/0525

(52) U.S. Cl. CPC H01M 10/0587; H01M 10/0525; H01M 4/485; H01M 2220/20

(57) ABSTRACT

A lithium-ion secondary battery including a wound body provided by winding a sheet unit around an axis, the sheet unit including a power-generating element provided by stacking a positive electrode unit and a negative electrode unit with a separator interposed between them, wherein the following expression (1) is satisfied:

0.02≦A/B≦0.05 (1)

where A represents a width of the separator from one end to a position corresponding to an end of an applied portion of the negative electrode unit, and B represents a width of the separator from the one end to the other end in the axial direction, and the positive electrode unit includes an active material particle forming a hollow structure including a secondary particle formed of a plurality of primary particles of lithium-transition metal oxide and a hollow portion formed inside the secondary particle, and the secondary particle has a through hole extending from an outside to the hollow portion.

### TECHNICAL FIELD

The present invention relates to a lithium-ion secondary battery including a wound body as a power-generating element.

### BACKGROUND ART

Chargeable and dischargeable Lithium-ion secondary batteries are known as a power source for a motor which drives a vehicle. The lithium-ion secondary battery of this type includes a wound body inside a battery case, and the wound body is formed by stacking a positive electrode and a negative electrode with a separator interposed between them. The positive electrode is provided by applying an active material and the like for the positive electrode to a collector for the positive electrode. The negative electrode is provided by applying an active material and the like for the negative electrode to a collector for the negative electrode.

Patent Document 1 has disclosed a non-aqueous electrolyte battery in which Aa>Ca, Ab>Cb, SLa>Ca/(1−Ra), and SLb>Cb/(1−Rb) are satisfied in order to prevent contact between a positive electrode and a negative electrode when a separator is thermally contracted, where Aa and Ab represent the lengths of a longer side and a shorter side of the negative electrode, respectively, Ca and Cb represent the lengths of a longer side and a shorter side of the positive electrode, respectively, SLa and Ra represent the length and the thermal contraction rate of the separator in a longer side direction, respectively, and SLb and Rb represent the length and the thermal contraction rate of the separator in a shorter side direction, respectively. In the configuration of Patent Document 1, only the conditions for the minimum separator width are specified. Thus, the object of Patent Document 1 is more likely to be achieved as the separator width is increased relative to the positive electrode width and the negative electrode width.

### PRIOR ART DOCUMENTS

### Patent Documents

[Patent Document 1] Japanese Patent Laid-Open No. 2003-217674
[Patent Document 2] Japanese Patent Laid-Open No. 2011-119092

### DISCLOSURE OF THE INVENTION

### Problems to be Solved by the Invention

If the separator width is extremely large, however, too much electrolytic solution is held within voids in the separator. When the lithium-ion secondary battery having a very large separator width is used, for example as a vehicle-mounted battery which is repeatedly charged and discharged at a high rate, the internal resistance may be increased to deteriorate input/output characteristics significantly.

At the same time, it is important to prevent contact between the positive electrode and the negative electrode when the separator is thermally contracted due to a battery abnormality such as overcharge, that is, to reduce a leak current after the separator is shut down.

It is thus an object of the present invention to provide a lithium-ion secondary battery in which a leak current after a separator is shut down is reduced and an increase in internal resistance can be suppressed.

### Means for Solving the Problems

To solve the problem, the present invention provides a lithium-ion secondary battery including a wound body provided by winding a sheet unit around an axis, the sheet unit including a power-generating element provided by stacking a positive electrode unit and a negative electrode unit with a separator interposed between them, wherein the following expression is satisfied:

0.02≦A/B≦0.05 (1)

where A represents a width of the separator from one end to a position corresponding to an end of an applied portion of the negative electrode unit, and B represents a width of the separator from the one end to the other end in the axial direction, and the positive electrode unit includes an active material particle forming a hollow structure including a secondary particle formed of a plurality of primary particles of lithium-transition metal oxide and a hollow portion formed inside the secondary particle, and the secondary particle has a through hole extending from an outside to the hollow portion.

### Advantage of the Invention

According to the present invention, the lithium-ion secondary battery can be provided in which a leak current after the separator is shut down is reduced and an increase in internal resistance can be suppressed.

### BRIEF DESCRIPTION OF THE DRAWINGS

FIG. 1 is a developed view of part of a wound body.

FIG. 2 is a section view of a sheet unit forming the wound body taken along a section A1-A2.

### MODE FOR CARRYING OUT THE INVENTION

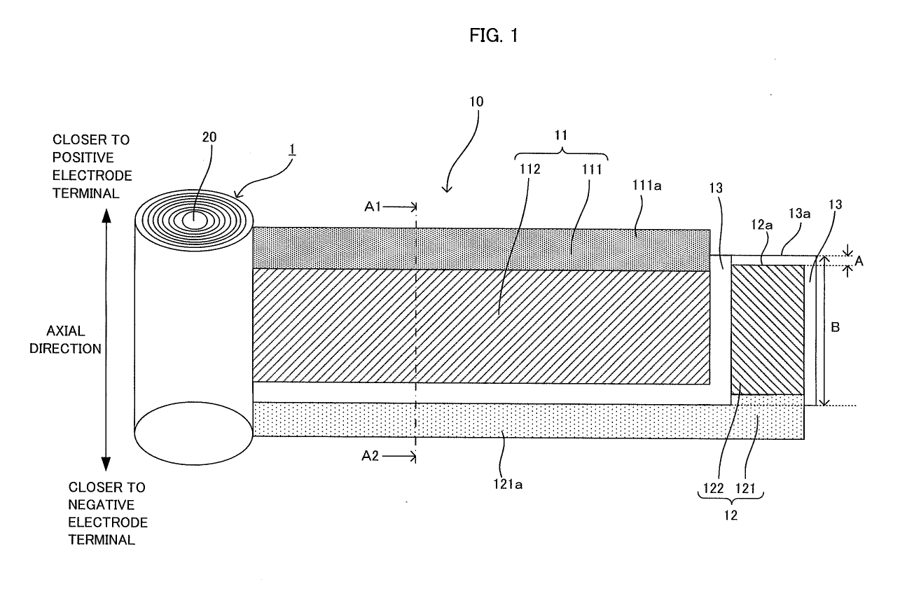

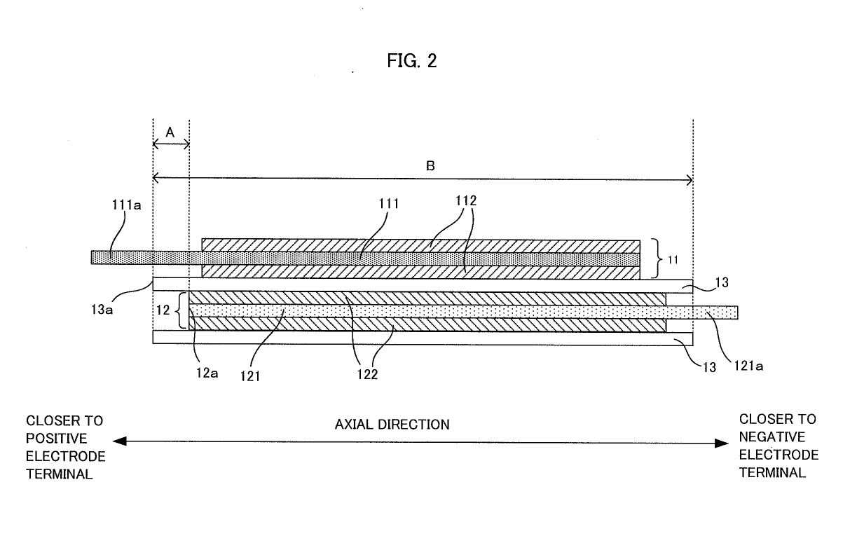

FIG. 1 is a developed view of part of a wound body. FIG. 2 is a section view of a sheet unit forming the wound body taken along a section A1-A2. A wound body 1 is a power-generating element of a lithium-ion secondary battery, is formed by winding a sheet unit 10 around a core member 20, and is housed in a case member, not shown, together with an electrolytic solution. The case member can be provided by using a cylindrical case or square case. The lithium-ion secondary battery can be used, for example, as a vehicle-mounted battery for storing electric power to be supplied to a motor for running a vehicle. Examples of the vehicle include a hybrid vehicle and an electric vehicle. The hybrid vehicle refers to a vehicle which employs both the vehicle-mounted battery and an internal-combustion engine as the power source. The electric vehicle refers to a vehicle which employs only the vehicle-mounted battery as the power source.

The sheet unit 10 includes a positive electrode unit 11, a negative electrode unit 12, and separators 13 placed at positions between which the negative electrode unit 12 is sandwiched. The separators 13 may be placed at positions between which the positive electrode unit 11 is sandwiched. The positive electrode unit 11 includes a positive electrode collector 111 of sheet form and a positive electrode material 112 applied to part of each face of the positive electrode collector 111. The area of the positive electrode collector 111 to which the positive electrode material 112 is not applied is referred to as a positive electrode unapplied portion 111a. As shown in FIG. 1, the positive electrode unapplied portion 111a is formed only in part of the positive electrode collector 111 at one end in an axial direction (end portion closer to a positive electrode terminal).

Aluminum can be used for the positive electrode collector 111. The positive electrode material 112 refers to a layer including positive electrode active material particles, a conductive agent, a binder and the like suitable for the positive electrode. The positive electrode active material particles can be provided by using various lithium-transition metal oxides which can reversibly absorb and release lithium. The lithium-transition metal oxide may have a layered structure or a spinel structure. The positive electrode active material particle has a hollow structure including a secondary particle formed of a plurality of primary particles of the lithium-transition metal oxide and a hollow portion formed inside the secondary particle. The secondary particle has a through hole extending from the outside to the hollow portion. Such a structure of the positive electrode active material particle is hereinafter referred to as a hollow structure.

The secondary particle can be produced, for example by sintering the primary particles. More specifically, the positive electrode active material particle having the above structure can be produced by using an aqueous solution containing at least one transition metal element included in the lithium ion-transition metal oxide, precipitating a hydroxide of the transition metal, and mixing and sintering the transition metal hydroxide and a lithium compound. The positive electrode active material particle described above can be used to limit an increase in internal resistance of the lithium-ion secondary battery since the electrolytic solution flows into the hollow portion from the outside through the through hole. The conductive agent can be provided by using a carbon material such as carbon powder and carbon fiber, or electrically conductive metal powder such as nickel powder.

The positive electrode unapplied portion 111a is located in the wound body 1 closer to the positive electrode terminal and protrudes in the axial direction. The positive electrode unapplied portion 111a is electrically connected to the positive electrode terminal, not shown, of the lithium-ion secondary battery.

The negative electrode unit 12 includes a negative electrode collector 121 of sheet form and a negative electrode material 122 applied to part of each face of the negative electrode collector 121. The area of the negative electrode collector 121 to which the negative electrode material 122 is not applied is referred to as a negative electrode unapplied portion 121a. As shown in FIG. 1, the negative electrode unapplied portion 121a is formed only in part of the negative electrode collector 121 at one end in the axial direction (end portion closer to a negative electrode terminal).

Copper can be used for the negative electrode collector 121. The negative electrode material 122 refers to a layer including negative electrode active material particles, a conductive agent and the like suitable for the negative electrode. The negative electrode active material particles can be provided by using carbon. The width of the negative electrode material 122 in the axial direction is larger than the width of the positive electrode material 112 in the axial direction.

The separators 113 disposed at the positions between which the negative electrode unit 12 is sandwiched are placed such that their ends in the axial direction are aligned. The following expression (1) is satisfied:

0.02≦A/B≦0.05 (1)

where A represents a width of the separator 13 (hereinafter referred to as a margin) from an end 13a of the separator 13 closer to the positive electrode terminal to a position corresponding to an end 12a of an applied portion of the negative electrode unit 12, and B represents an overall width of the separator 13 in the axial direction (hereinafter referred to as a separator width).

When A/B is 0.02 or higher, a problem resulting from a small margin A, that is, a leak current after the separator 13 is shut down, can be suppressed.

When A/B is 0.05 or lower, a problem resulting from a large margin A, that is, an increase in internal resistance of the lithium-ion secondary battery charged and discharged at a high rate (high rate deterioration) can be suppressed. The high rate deterioration refers to an increased internal resistance due to an uneven salt concentration in the active material (positive electrode active material or negative electrode active material). Thus, the charge and discharge at a high rate means charge and discharge of the lithium-ion secondary battery at a current rate at which the internal resistance is increased as described above.

Preferably, the margin A and the separator width B satisfies the following expression (2) and the positive electrode active material particle has a Di-butyl phthalate (DBP) absorption amount of 30 to 45 ml/100 g.

0.03≦A/B≦0.05 (2)

These conditions can be satisfied to more preferably reduce the leak current after the separator 13 is shut down. The DBP absorption amount (see JIS K6217-4) is an indicator of a wetted area of the positive electrode active material. The DBP absorption amount can be changed by varying reaction times in a “nucleation phase” and a “particle growth phase,” later described.

As described above, according to the configuration of the present embodiment, the ratio between the margin A and the separator width B can be limited to the predetermined range to suppress an increased internal resistance due to the high rate deterioration and to reduce the leak current after the separator 13 is shut down. In a conventional configuration in which the margin A is large, the high rate characteristics are sacrificed and the configuration is designed inevitably with no robustness. In contrast, according to the configuration of the present embodiment, an increased internal resistance due to the high rate deterioration is suppressed to enhance the robustness and to limit deterioration of input/output characteristics, and the leak current can be reduced at the same time.

Next, the present invention is descried more specifically with Example. Positive electrode active material particles (having the hollow structure with through hole) used in a lithium-ion secondary battery of Example were produced in the following manner. Ion-exchanged water was put into a reaction tank in which the temperature was set at 40° C., nitrogen gas was flowed during agitation to perform nitrogen substitution for the ion-exchanged water, and the reaction tank was adjusted to provide a non-oxidizing atmosphere containing oxygen gas (O₂) at a concentration of 2.0%. Then, 25% sodium hydroxide solution and 25% ammonia water were added to achieve a pH of 12.5 and an NH₄⁺ concentration of 5 g/L in solution measured with reference to a solution temperature of 25° C.

Nickel sulfate, cobalt sulfate, and manganese sulfate were dissolved in water to provide a mole ratio for Ni:Co:Mn of 0.33:0.33:0.33 and a total mole concentration for these metal elements of 1.8 mol/L, thereby preparing a mixed aqueous solution. The mixed aqueous solution, the 25% NaOH aqueous solution, and the 25% ammonia water were supplied into the reaction tank at a constant rate. While the reaction solution was controlled at a pH of 12.5 and an NH₄⁺ concentration of 5 g/L, NiCoMn composite hydroxide was crystallized from the reaction solution (nucleation phase).

After the elapse of 2 minutes and 30 seconds since the start of the supply of the mixed aqueous solution, the supply of 25% NaOH aqueous solution was stopped. The mixed aqueous solution and 25% ammonia water continued to be supplied at the constant rate. After the pH of the reaction solution was reduced to 11.6, the supply of 25% NaOH aqueous solution was resumed. While the reaction solution was controlled at a pH of 11.6 and an NH₄⁺ concentration of 5 g/L, the supply of the mixed aqueous solution, 25% NaOH aqueous solution, and 25% ammonia water was continued for 4 hours to grow NiCoMn composite hydroxide particles (particle growth phase). Then, the product was taken out of the reaction tank, washed with water, and dried. Thus, the composite hydroxide particles represented as Ni_{0.33}Co_{0.33}Mn_{0.33}(OH)_{2+α} (where 0≦α≦0.5) were obtained.

The composite hydroxide particles were subjected to heat treatment in an atmospheric environment at 150° C. for 12 hours. Then, Li₂CO₃ serving as a lithium source and the composite hydroxide particles were mixed at a 1.15:1 ratio (M_{Li}:M_{Me}) between the number of moles of lithium (M_{Li}) and the total number of moles of Ni, Co, and Mn (M_{Me}) constituting the composite hydroxide. The mixture was burned at 760° C. for 4 hours (first burning phase), and then burned at 950° C. for 10 hours (second burning phase). Then, the burned mixture was cracked and screened. Thus, the active material particle sample of the composition represented as Li_{1.15}Ni_{0.33}Co_{0.33}Mn_{0.33}O₂ was obtained. The positive electrode active material particles had an average particle diameter D50 of 5 μm. The average particle diameter D50 refers to a so-called median diameter.

Positive electrode active material particles (having a solid structure) used in a lithium-ion secondary battery of Comparative Example were produced in the following manner. Ion-exchanged water was put into a reaction tank in which an overflow pipe was provided and the temperature was set at 40° C., nitrogen gas was flowed during agitation to perform nitrogen substitution for the ion-exchanged water, and the reaction tank was adjusted to provide a non-oxidizing atmosphere containing oxygen gas (O₂) at a concentration of 2.0%. Then, 25% sodium hydroxide solution and 25% ammonia water were added to achieve a pH of 12.0 and an NH₄⁺ concentration of 15 g/L in solution measured with reference to a solution temperature of 25° C.

Nickel sulfate, cobalt sulfate, and manganese sulfate were dissolved in water to provide a mole ratio for Ni:Co:Mn of 0.33:0.33:0.33 and a total mole concentration for these metal elements of 1.8 mol/L, thereby preparing a mixed aqueous solution. The mixed aqueous solution, the 25% NaOH aqueous solution, and the 25% ammonia water were supplied into the reaction tank at a constant rate at which NiCoMn composite hydroxide particles precipitated in the reaction tank had an average residence time of 10 hours. While the reaction solution was controlled at a pH of 12.0 and an NH₄⁺ concentration of 15 g/L, NiCoMn composite hydroxide was continuously crystallized. After the reaction tank enters a steady state, the NiCoMn composite hydroxide (product) was continuously taken through the overflow pipe, washed with water, and dried. Thus, the composite hydroxide particles of the composition represented as Ni_{0.33}Co_{0.33}Mn_{0.33} (OH)_{2+α} (where 0≦α≦0.5) were obtained.

The composite hydroxide particles were subjected to heat treatment in an atmospheric environment at 150° C. for 12 hours. Then, Li₂CO₃ serving as a lithium source and the composite hydroxide particles were mixed at a 1.15:1 ratio (M_{Li}:M_{Me}) between the number of moles of lithium (M_{Li}) and the total number of moles of Ni, Co, and Mn (M_{Me}) constituting the composite hydroxide. The mixture was burned at 760° C. for 4 hours, and then burned at 950° C. for 10 hours. Then, the burned mixture was cracked and screened. Thus, the positive electrode active material particle sample of the composition represented as Li_{1.15}Ni_{0.33}Co_{0.33}Mn_{0.33}O₂ was obtained.

The positive electrode unit 11 used in the lithium-ion secondary battery was produced in the following manner. Each of the active material particle samples obtained as described above, acetylene black serving as a conductive material, and PVDF were mixed with NMP at a mass ratio for these materials of 85:10:5 and at a solid content concentration (NV) of approximately 50% by mass, thereby preparing a positive electrode mixture composition for each active material particle sample.

Each of the positive electrode mixture compositions was applied to both faces of a long aluminum foil (collector for positive electrode) having a thickness of 15 μm. The total amount of the applied composition to both faces was adjusted to approximately 12.8 mg/cm² based on a solid content. After the applied composition was dried, roll press was performed to provide a positive electrode unit having a positive electrode mixture layer on both faces of the collector. The overall thickness of the positive electrode unit was approximately 70 μm.

Negative electrode active material particles used in the lithium-ion secondary batteries of Example and Comparative Example were produced in the following manner. Natural graphite particles, SBR, and CMC were mixed with ion-exchanged water at a mass ratio for these materials of 98:1:1 and at an NV of 45% by mass, thereby preparing an aqueous active material composition (negative electrode mixture composition). The composition was applied to both faces of a long copper foil (collector for negative electrode) having a thickness of 10 μm and dried, and roll press was performed. Thus, a sheet negative electrode (negative electrode unit) having a negative electrode mixture layer on both faces of the collector was produced. The overall thickness of the negative electrode unit was approximately 50 μm.

Eleven types of lithium-ion secondary batteries having the positive electrode active material particles formed in the hollow structure with through hole were produced at varying ratios (A/B) between the margin A and the separator width B. Eleven types of lithium-ion secondary batteries having the positive electrode active material particles formed in the solid structure were produced at varying ratios (A/B) between the margin A and the separator width B. An overcharge test and a high-rate cycle test were conducted on these lithium-ion secondary batteries.

In the overcharge test, the initial temperature was set at −10° C., and the State of Charge (SOC) of each lithium-ion secondary battery was set at 30%. Then, each lithium-ion secondary battery was overcharged at a charge rate of 10 C, and the separator was shut down by self-heating. After the shut-down, a voltage of 15 V was applied to each lithium-ion secondary battery to measure a very small short-circuit current (leak current).

In the high-rate cycle test, each lithium-ion secondary battery was repeatedly charged and discharged at a charge/discharge rate of 20 C to measure a resistance increase rate of each lithium-ion secondary battery after 5000 cycles. Table 1 shows the test results of the overcharge test. Table 2 shows the test results of the high-rate cycle test.

It can be seen from Table 1 and Table 2 that the positive electrode active material particles formed in the hollow structure with through hole and the ratio A/B limited to a range from 0.02 to 0.05 can reduce the leak current after the shut-down of the separator and can suppress an increase in resistance increase rate simultaneously.

The overcharge test described above was conducted on a lithium-ion secondary battery having an A/B ratio of 0.025 and a lithium-ion secondary battery having an A/B ratio of 0.047 at 5 different levels of DBP absorption amount. Table 3 shows the test results.

It can be seen from Table 3 that, when the positive electrode active material particles of the hollow structure with through hole are used, the ratio A/B limited to a range from 0.03 to 0.05 and the DBP absorption amount limited to a range from 30 to 45 ml/100 g can reduce the leak current more effectively.

### DESCRIPTION OF THE REFERENCE NUMERALS

1 WOUND BODY 10 BATTERY CASE 13 POWER-GENERATING ELEMENT 14 CORE MEMBER 131 POSITIVE ELECTRODE UNIT 131a COLLECTOR FOR POSITIVE ELECTRODE 131b EXTENDING PORTION 131c POSITIVE ELECTRODE MATERIAL 132 NEGATIVE ELECTRODE UNIT 132a COLLECTOR FOR NEGATIVE ELECTRODE 132b EXTENDING PORTION 132c NEGATIVE ELECTRODE MATERIAL 133 SEPARATOR

1. A lithium-ion secondary battery comprising a wound body provided by winding a sheet unit around an axis, the sheet unit including a power-generating element provided by stacking a positive electrode unit and a negative electrode unit with a separator interposed between them,
wherein the following expression (1) is satisfied:
0.02≦A/B≦0.05 (1)
where A represents a width of the separator from one end to a position corresponding to an end of an applied portion of the negative electrode unit, and B represents a width of the separator from the one end to the other end in the axial direction, and the positive electrode unit includes an active material particle forming a hollow structure including a secondary particle formed of a plurality of primary particles of lithium-transition metal oxide and a hollow portion formed inside the secondary particle, and the secondary particle has a through hole extending from an outside to the hollow portion.

2. The lithium-ion secondary battery according to claim 1, wherein the following expression (2) is satisfied;
0.03≦A/B≦0.05 (2)
and the positive electrode active material particle has a Di-butyl phthalate (DBP) absorption amount of 30 to 45 ml/100 g.

3. The lithium-ion secondary battery according to claim 1, wherein the lithium-ion secondary battery is a vehicle-mounted battery configured to store electric power to be supplied to a motor for running a vehicle.

4. The lithium-ion secondary battery according to claim 2, wherein the lithium-ion secondary battery is a vehicle-mounted battery configured to store electric power to be supplied to a motor for running a vehicle.
